(19) United States
(12) Patent Application Publication
(10) Pub. No.: US 2009/0220852 A1
(43) Pub. Date: Sep. 3, 2009

(54) Battery pack secured by end plates

(76) Inventor: Kazuhiro Fujii, Taka-gun (JP)

Correspondence Address: WENDEROTH, LIND & PONACK, L.L.P., 1030 15th Street, N.W.,, Suite 400 East, Washington, DC, 20005-1503, US

(21) Appl. No.: 12/379,671

(22) Filed: Feb. 26, 2009

(30) Foreign Application Priority Data
Feb. 28, 2008 (JP) 2008-48507

(51) Int. Cl. H01M 2/10; H01M 2/36

(52) U.S. Cl. 429/72; 429/99; 429/97; 429/98

(57) ABSTRACT

In the battery pack, a battery holder accommodates a plurality of cylindrical batteries disposed in a matrix or offset arrangement in a mutually parallel posture. The battery holder includes a holder main body and an end plate respectively connected to opposite ends of the holder main body having a plurality of opposed walls disposed in a mutually parallel posture inside peripheral walls, and also having a storage portion accommodating the cylindrical batteries between the opposed walls. The opposed wall is provided, on its opposite faces, with a protrusion projecting toward the swale between the adjacent cylindrical batteries to constitute a thick portion defining a through-hole extending through in the longitudinal direction of the cylindrical battery. A connection rod is inserted in the through-hole defined in the above-mentioned thick portion, and the end plate is secured to the opposite ends of the holder main body by means of the connection rod.

### BACKGROUND OF THE INVENTION

1. Field of the Invention

The present invention relates to a battery pack where a plurality of cylindrical batteries are contained in a battery holder and disposed in a fixed position, and particularly to a battery pack which is optimal as a power source mounted on a vehicle to supply electric power to a motor for driving the vehicle.

2. Description of the Related Art

Like in the case of a power source for a vehicle, a battery pack requiring larger output power has a multitude of batteries connected in series or in parallel. In order to retain the multitude of batteries in a fixed position, such battery pack is accommodated in a plastic-made battery holder. In order to accommodate the multitude of batteries in multiple tiers or rows, the battery holder accommodates the batteries disposed in a matrix or offset arrangement in a mutually parallel posture. The battery holder accommodating the multitude of batteries is so shaped as to have its opposite ends opened to be provided with an insertion portion for each of the batteries to be inserted in, and thus the multitude of batteries can be inserted into a single piece of battery holder to be disposed in a fixed position. A battery pack thus structured is described in JP No. 2004-171856-A.

FIG. 1 is an exploded perspective view of the battery pack described in JP No. 2004-171856-A. This battery pack has an end plate 93 secured respectively to opposite sides of the battery holder 92. The battery holder 92 has a battery storage portion 94 opened at opposite ends to accommodate a multitude of cylindrical batteries 91 disposed in a matrix arrangement. In the battery pack shown in FIG. 1, the battery holder 92 is divided into two parts in the longitudinal direction (in the vertical direction when viewed in the drawing) of the cylindrical battery 91, with the battery holder 92 being composed of an upper holder 92A and a lower holder 92B. The battery holder 92 has the upper holder 92A and the lower holder 92B mutually connected to accommodate the multitude of cylindrical batteries 91 in the battery storage portion 94. In a state that the cylindrical batteries 91 are inserted in the battery storage portions 94 of the upper holder 92A and the lower holder 92B, the battery holder 92 mutually connects the upper holder 92A and the lower holder 92B to constitute the battery holder 92. The upper holder 92A and the lower holder 92B are connected and secured by means of a connection member (not shown). The upper holder 92A and the lower holder 92B are provided with a ridge 95 projecting outside the peripheral walls, for the connection member to be inserted into the ridge 95.

Further, the battery pack is so constructed and arranged that while the multitude of cylindrical batteries 91 are connected by means of a connection plate 96 connected to the terminal electrode of the cylindrical battery 91 which is exposed out of openings at the opposite faces of the battery holder 92, the end plate 93 is secured to opposite faces of the battery holder 92, and the opposite faces of the battery holder 92 are respectively sealed by the end plate 93. The end plate 93 is fitted in and positioned at the periphery of the openings on the opposite faces of the battery holder 92, and is then secured by ultrasonically welding the peripheral edge of the end plate 93 in joint with the periphery of the openings of the battery holder 92.

The battery holder 92 thus structured is disadvantageous in that its contour becomes larger due to the structure of having the connection member. Further, since the battery holder 92 is welded to be connected with the end plate 93, the structure of accommodating the multitude of batteries suffers the disadvantage that it is difficult to connect the battery holder 92 and the end plate 93 in a firm, strong manner. In particular, since the battery holder 92 and the end plate 93 are connected by welding the peripheral edge of the end plate 93 in joint with the periphery of the opening of the battery holder 92, such arrangement suffers the disadvantage that connection strength becomes weaker at the center portion of the end plate 93. For example, the battery pack shown in FIG. 1 accommodates the batteries in two rows. Suppose that the battery pack were so structured as to accommodate the batteries in three or more rows. The wider an interval between the welded portions where the battery holder and the opposing end plate are mutually welded, the weaker the mechanical strength of such structure in aiming at firmly securing the end plate to the battery holder. To avoid such disadvantage, if the end plate is to be formed thicker in obtaining a wider welded portion, such formation will inevitably involve a higher cost of manufacture as well as a heavier and larger structure.

The present invention has been made to overcome the above described drawbacks. It is a primary object to provide a battery pack that effectively utilizes a space existing among cylindrical batteries and enables a pair of end plates to be firmly secured to a battery holder. Further, another vital object of the present invention is to provide a battery pack that effectively utilizes a structure of efficiently cooling each of the batteries and enable the end plates to be firmly secured to the battery holder, without the contour of the peripheral wall being enlarged.

### SUMMARY OF THE INVENTION

The battery pack includes a plurality of cylindrical batteries 1 and a plastic-made battery holder 2, 52 accommodating the plurality of batteries 1 disposed in a matrix or offset arrangement in a mutually parallel posture. The battery holder 2, 52 includes a holder main body 10 accommodating the cylindrical batteries 1 and an end plate 20, 60 respectively connected to opposite ends of the holder main body 10. Further, the holder main body 10 has a plurality of opposed walls 12 disposed in a mutually parallel posture inside peripheral walls 11, and also has a storage portion 13 accommodating the plurality of cylindrical batteries 1 between the opposed walls 12. Furthermore, the opposed wall 12 is provided, on its opposite faces, with a protrusion 14 projecting toward the swale between the adjacent cylindrical batteries 1 to constitute a thick portion 15, and the thick portion 15 defines a through hole 16 extending through in the longitudinal direction of the cylindrical battery 1. In the battery pack, a connection rod 8 is inserted in the through hole 16 defined in the thick portion 15 of the holder main body 10, and the end plate 20, 60 is secured to the opposite ends of the holder main body 10 by means of the connection rod 8.

In the battery pack structured as above, effective utilization of the space defined between the cylindrical batteries enables the pair of end plates to be firmly secured to the battery holder. This is because the opposed walls are respectively provided with the thick portion projecting toward the swale between the adjacent cylindrical batteries, a through hole is defined in the thick portion, and thus the connection rod is inserted through the through hole to secure the end plate. Further, when the protrusion is provided so as to project toward the swale between the adjacent cylindrical batteries and the thick portion is provided to the opposed wall, such structure also realizes the characteristic of enabling the end plate to be firmly secured to the battery holder, without enlarging the contour of the peripheral wall while effectively utilizing the structure of efficiently cooling each of the batteries. This is because the provision of the protrusion to the opposed wall enables the inner surface of the opposed wall to approach the surface of the cylindrical battery so as to accelerate the velocity of the fluid flowing between the opposed wall and the cylindrical battery. Particularly, such structure carries the characteristic that because the connection rod is inserted through the thick portion made up by the protrusion for efficiently cooling the battery, the end plate can be firmly secured while the cylindrical batteries being disposed to be mutually closer and without the peripheral wall being enlarged.

The battery pack described above, further, carries the characteristic that when a battery pack is structured to accommodate the batteries in multi tiers of more than three tiers, the end plate can also be firmly secured to the battery holder. This is because the middle portion of the end plate can be connected for securing operation.

In the battery pack of the present invention, a cooling gap 7 is defined between the opposed wall 12 and the cylindrical battery 1 to cause the fluid to flow for cooling the battery, and thus the cylindrical battery can be efficiently cooled in a wider area.

In the battery pack of the present invention, a cooling medium is forcibly blown through the through hole 16 to cool the cylindrical battery 1 in the storage portion 13, and thus the cylindrical battery can be efficiently cooled via the battery holder.

In the battery pack of the present invention, the end plate 20, 60 is so structured as to have a fitting-on portion 22 for disposing a bus bar 5 in a fixed position, the bus bar 5 being connected to a terminal electrode 6 of the cylindrical battery 1 accommodated in the holder main body 10, and thus the bus bar can be disposed in a fixed position by means of the end plate.

Further, in the battery pack of the present invention, the end plate 20 can be so structured as to have an insertion retainer 27 for inserting and retaining the end of the cylindrical battery 1 in a fixed position, the cylindrical battery 1 being accommodated in the storage portion 13 of the holder main body 10. The battery pack enables the cylindrical battery to be disposed in a fixed position by means of the end plate. Particularly in this structure, when so structured as to have a cooling gap around the surface of the cylindrical battery, the cylindrical battery can have an accurate cooling gap around the surface of the cylindrical battery for an efficient cooling operation.

Furthermore, in the battery pack of the present invention, the holder main body 10 can be so structured as to have a retention protrusion 29 for retaining the inserted cylindrical battery 1 in a fixed position, the retention protrusion 29 being on the inner surface of the storage portion 13. The battery pack enables the cylindrical battery to be disposed in a fixed position by inserting the battery through the battery holder.

The above and further objects of the present invention as well as the features thereof will become more apparent from the following detailed description to be made in conjunction with the accompanying drawings.

### BRIEF DESCRIPTION OF THE DRAWINGS

FIG. 1 is an exploded perspective view showing a conventional type of battery pack;

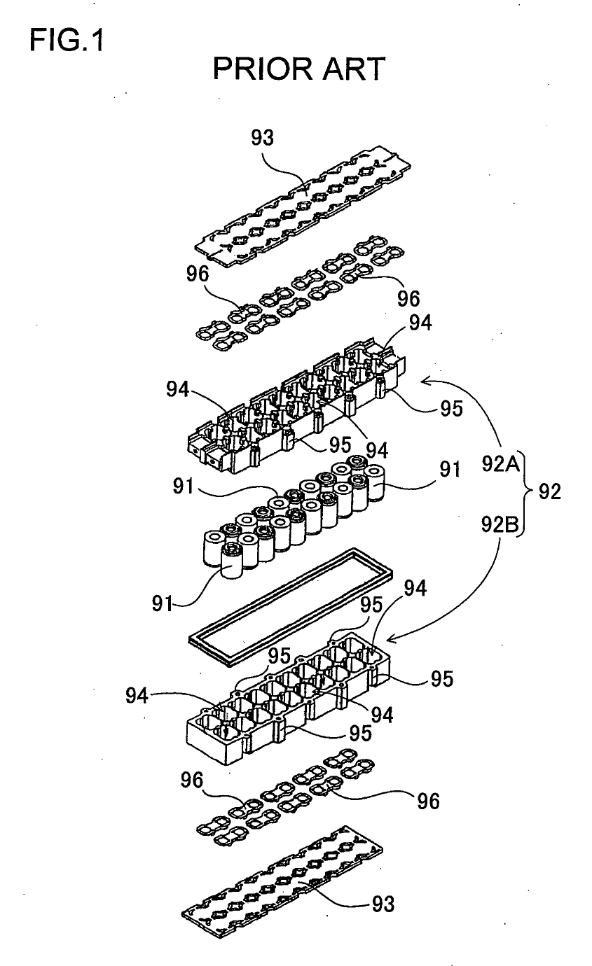

FIG. 2 is a perspective view of the battery pack in accordance with an embodiment of the present invention;

FIG. 3 is an enlarged, horizontal, sectional view of the battery pack shown in FIG. 2;

FIG. 4 is a perspective view of the battery holder for the battery pack shown in FIG. 2;

FIG. 5 is a perspective view of the holder main body for the battery holder shown in FIG. 4;

FIG. 6 is a perspective view of the end plate for the battery holder shown in FIG. 4;

FIG. 7 is a vertical, latitudinal, sectional view of the battery pack shown in FIG. 2, and is a view corresponding to the sectional view taken along line A-A in FIG. 3 and FIG. 4;

FIG. 8 is a horizontal, latitudinal, sectional view of the battery pack shown in FIG. 2, and is a view corresponding to the sectional view taken along line B-B in FIG. 3 and FIG. 4;

FIG. 9 is a perspective view showing an alternative example of the battery holder; and

FIG. 10 is a perspective view showing the end plate for the battery holder shown in FIG. 9.

### DETAILED DESCRIPTION OF THE EMBODIMENT(S)

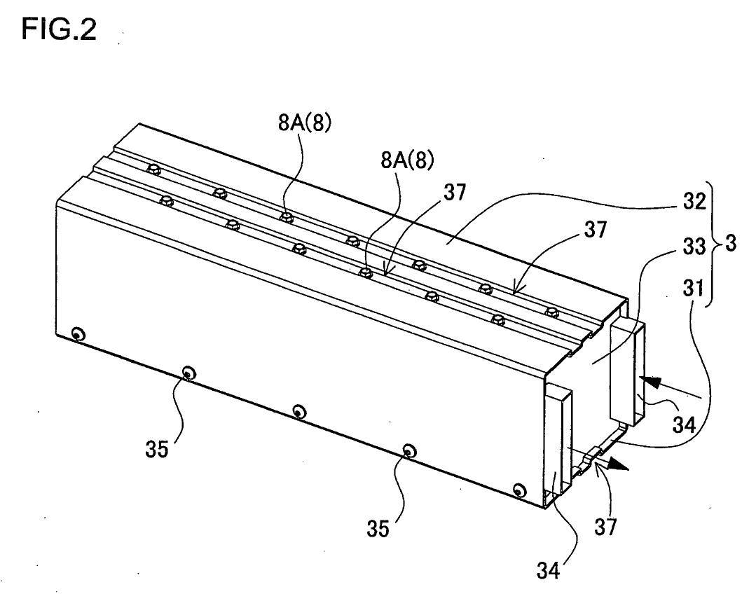

The battery pack shown in FIG. 2 through FIG. 8 includes a plurality of cylindrical batteries 1 and a plastic-made battery holder 2 accommodating the plurality of cylindrical batteries 1 disposed in a matrix or offset arrangement in a mutually parallel posture. Further, the battery pack shown in FIGS. 2, 3, 7 and 8 includes an outer casing 3 for accommodating the battery holder 2, and a cooling duct 4 is provided between the outer casing 3 and the battery holder 2.

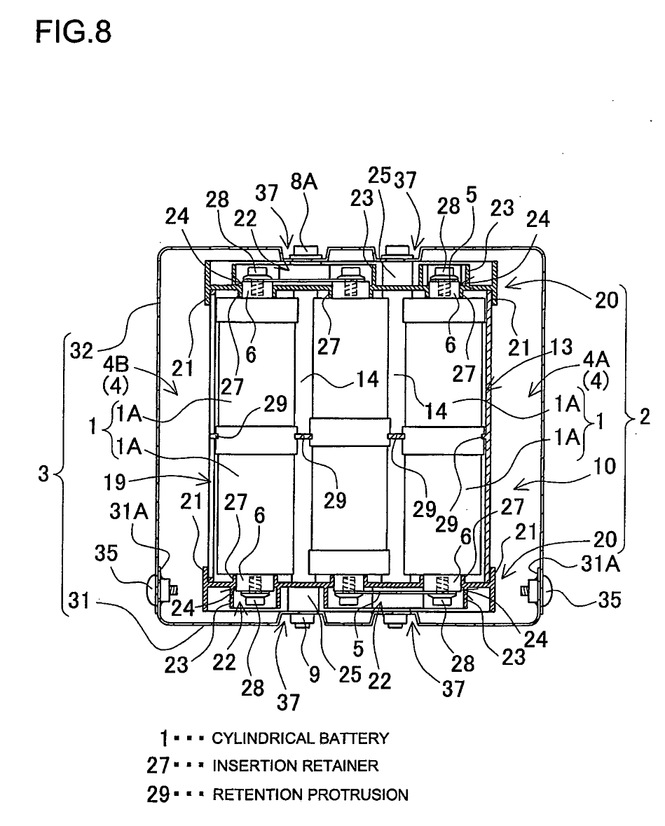

The cylindrical battery 1 to be used can be any kind of rechargeable battery such as a nickel-hydrogen battery and a lithium-ion battery. The cylindrical battery 1 shown in FIG. 8 is composed of two pieces of unit cells 1A interconnected linearly, and has terminal electrodes 6 secured at the opposite ends, to which a bus bar 5 is connectable. It is also practical and practicable that the cylindrical battery 1 is composed of either a single piece of battery or three or more pieces of batteries.

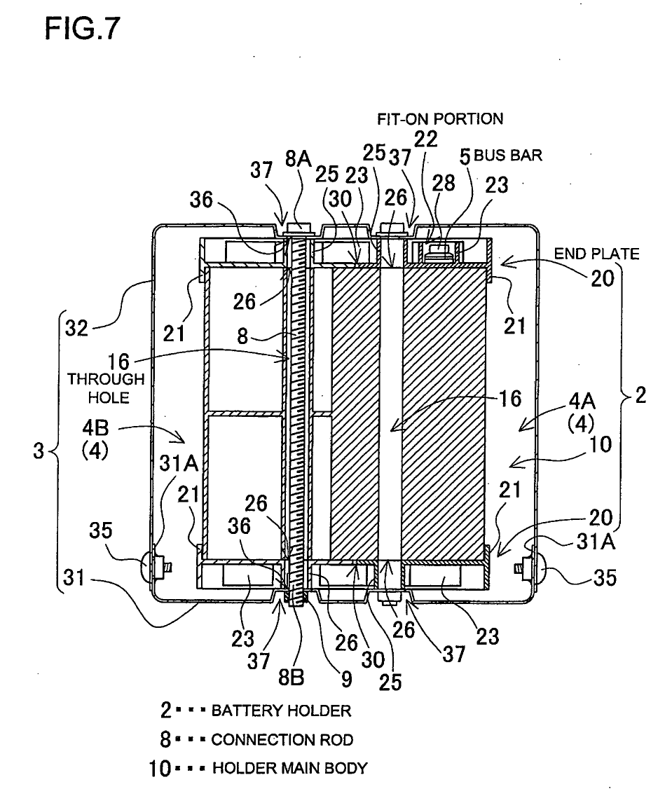

The outer casing 3 is a metallic casing and is composed of a bottom casing 31, a top casing 32 connected to a side wall 31A of the bottom casing 31, and an end face plate 33 for respectively sealing the opposite apertures defined by the bottom casing 31 and the top casing 32. The bottom casing 31 is fabricated by folding a metallic plate into a shape of having a side wall 31A respectively at opposite sides. As shown in the cross-sectional views in FIG. 7 and FIG. 8, the bottom casing 31 has its inner width wider than an outer width of the battery holder 2 so that a cooling duct 4 may be disposed respectively on opposite sides of the battery holder 2. The top casing 32 is fabricated by folding a metallic plate into a groove shape that can cover the top surface and the opposite side surfaces of the battery holder 2 and can also dispose the cooling duct 4 on the opposite sides of the battery holder 2, and then lower edges are secured to the bottom casing 31 by means of set screws 35. In the battery pack shown in FIG. 2, as viewed in this drawing, the end face plate 33 sealing the right end of the outer casing 3 is provided with connection ducts 34 connected to the cooling duct 4 existing between the battery holder 2 and the outer casing 3. Although not shown, the end face plate sealing the left side of the outer casing 3 in FIG. 2 seals the aperture defined by the bottom casing 31 and the top casing 32.

In the battery pack shown in FIG. 7 and FIG. 8, as viewed in the drawings, a cooling duct 4A on an inlet side is disposed on the right side of the battery holder 2, and a cooling duct 4B on the outlet side is disposed on the left side of the battery holder 2. The battery pack is so designed as to cool the battery when a fluid such as air for cooling the battery flows into the battery holder 2 from the cooling duct 4A on the inlet side and the fluid is exhausted outside from the cooling duct 4B on the outlet side. The fluid such as air serves to cool the battery when passing through the cooling gap 7 defined between the surface of the cylindrical battery 1 and the opposed wall 12 of the battery holder 2. The fluid flowing through the cooling gap 7 is air. It should be noted, however, the fluid flowing through the cooling gap 7 can also be a fluid composed of either a gas other than the air or a liquid. An explanation shall be made in detail below, based on the air to be used as the fluid flowing through the cooling gap 7 to cool the battery, but the fluid is not specifically limited to the air.

The battery holder 2 includes: the holder main body 10 accommodating the batteries; and the end plate 20 connected to the opposite ends of the holder main body 10.

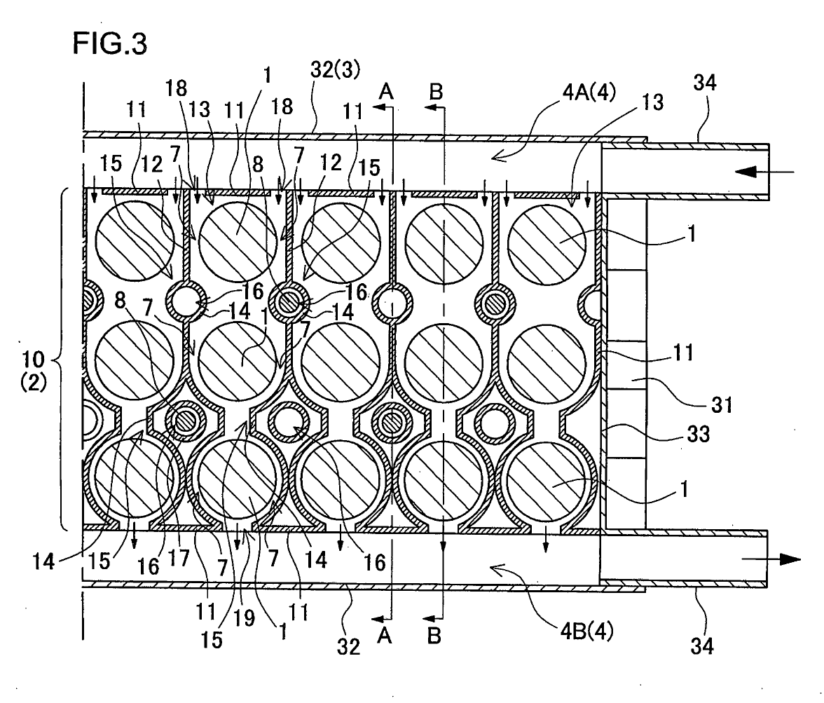

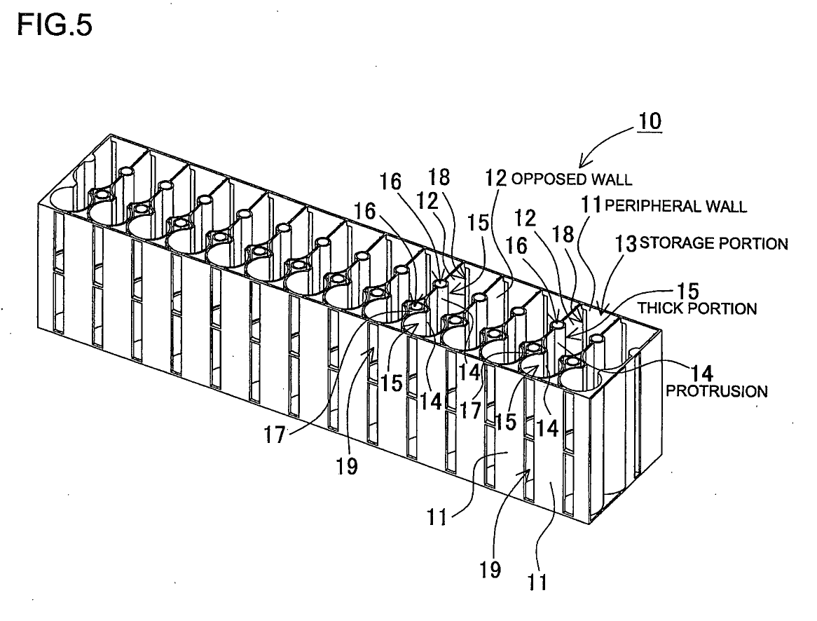

The holder main body 10 has its entirety integrally formed with a plastic material. As shown in the sectional view in FIG. 3 and in the perspective view in FIG. 5, the holder main body 10 has a plurality of opposed walls 12 disposed in a mutually parallel posture inside the peripheral walls 11 and also has a storage portion 13 disposed for accommodating the plurality of cylindrical batteries 1 between the opposed walls 12. The holder main body 10 has the cooling gap 7 defined between the opposed wall 12 and the cylindrical battery 1 to cause the air to flow for cooling the battery. Further, the opposed wall 12 is provided, on its opposite faces, with a protrusion 14 projecting toward the swale defined between the adjacent cylindrical batteries 1 to form a thick portion 15. The protrusion 14 allows an inner surface of the opposed wall 12 to approach the surface of the cylindrical battery 1, thus narrowing the cooling gap 7 between the battery and the inner surface of the opposed wall 12. Further, in the holder main body 10 shown in FIG. 7 and FIG. 8, the height of the protrusion 14 projecting toward the swale between the adjacent cylindrical batteries 1 is made larger in the leeward than in the windward. The protrusion 14 projecting high serves to accelerate the velocity of air by narrowing the cooling gap 7 defined around the surface of the battery. Therefore, the battery holder 2 thus structured is capable of uniformly cooling the cylindrical batteries 1 both in the windward and in the leeward. This is because even when the temperature of the fluid such as the air is elevated in the leeward, the fluid is efficiently cooled due to the higher velocity of the air. Particularly, when the protrusion 14 in the leeward is formed to follow along the surface of the cylindrical battery 1, the air is blown at a high speed for an efficient cooling operation over a wide area of the surface of the cylindrical battery 1 in the leeward.

The thick portion 15 of the opposed wall 12 produced by the protrusion 14 has a through hole 16 extending through in the longitudinal direction of the cylindrical battery 1. Since the illustrated battery holder 2 accommodates the cylindrical batteries 1 in three rows, the opposed wall 12 has two pieces of protrusions 14 on the opposite sides, resultantly with the thick portion 15 being formed in two places. The illustrated opposed wall 12 has the protrusion 14 respectively at the boundary of the cylindrical batteries 1 disposed in the first and second rows and at the boundary of the cylindrical batteries 1 disposed in the second and third rows. The thick portion 15 in the windward is cylindrical, has a through hole 16 inside for insertion of the connection rod 8, and has the protrusion 14, with its cross section being shaped to be semicircular, at the opposite sides of the opposed wall 12. The thick portion 15 in the leeward is larger than the thick portion in the windward, with the surface of the protrusion 14 being shaped to follow along the surface of the cylindrical battery 1, and has a tube 17 inside for insertion of the connection rod 8.

Further, as shown in the sectional view in FIG. 3, the holder main body 10 has an inlet 18 and outlet 19 to allow the fluid such as air for cooling the battery to flow through. The inlet 18 and the outlet 19 are respectively shaped in a slit form extending in the longitudinal direction of the cylindrical battery 1, and thus the air is blown over the entire cylindrical battery 1. The inlet 18 is opened on the opposite sides of respective storage portions 13, while the outlet 19 is opened in the center portion of the respective storage portions 13. In the holder main body 10, the air coming in through the inlet 18 disposed on the opposite sides of the respective storage portions 13 passes by the opposite sides of the cylindrical battery 1, that is, the air is blown from the top to the bottom as viewed in FIG. 3, and then goes outside the holder main body 10 through the outlet 19. Therefore, the battery pack is so designed as to forcibly blow the air, for cooling the battery, in the sequential route of the cooling duct 4A on the inlet side, the inlet 18, the cooling gap 7, the outlet 19, and the cooling duct 4B on the outlet side.

In the case of the above-described battery pack, since the cylindrical batteries 1 are accommodated in three rows between a pair of opposed walls 12, the two thick portions 15 are provided, through which the through hole is defined respectively. In the case of a battery pack where the cylindrical batteries are accommodated in two rows between the opposed walls, a single piece of thick portion can be disposed on the opposed wall, through which a through hole is defined. Further, the battery pack of the present invention can be so structured as to accommodate the cylindrical batteries in four or more rows between the pair of opposed walls, having one to three pieces of thick portions in the opposed walls, through which thick portions the through hole is respectively defined so that the connection rod is inserted through the hole to connect the end plates together.

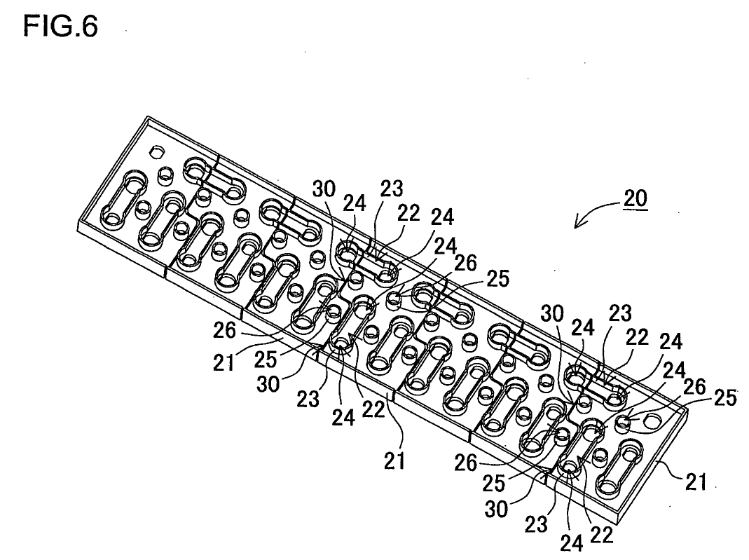

The end plate 20 has a fit-on wall 21 integrally formed along the periphery. In the end plate 20, the peripheral wall 11 of the holder main body 10 is inserted inside the fit-on wall 21 to be connected to a fixed position of the holder main body 10. Further, the end plate 20 has a fit-on portion 22 to dispose the bus bar 5 in a fixed portion, the bus bar 5 being connected to the terminal electrode 6 of the cylindrical battery 1 accommodated in the holder main body 10. The end plate 20 shown in FIG. 6 has a fit-on rib 23 integrally formed along the periphery of the fit-on portion 22. Extended through the opposite ends of the fit-on portion 22 is a stopper hole 24 for securing the bus bar 5 to the terminal electrode 6 of the cylindrical battery 1. The stopper hole 24 serves to pass the set screw 28 on to the terminal electrode 6 of the cylindrical battery 1 after extending through the bus bar 5, and thus the bus bar 5 is secured to the terminal electrode 6.

Further, the end plate 20 has a connection hole 26 defined for insertion of the connection rod 8 which is inserted through the through hole 16 of the holder main body 10. The end plate 20 shown in FIG. 6 has a support rib 25 integrally formed also in the periphery of the connection hole 26, the support rib 25 projecting from the surface. The support rib 25 is equal to the fit-on rib 23 in height, or projects higher than the fit-on rib 23 to contact the inner surface of the outer casing 3, and thus the outer casing 3 secured to the outside of the end plate 20 is supported from the inner surface.

Furthermore, as shown in the sectional view in FIG. 8, the end plate 20 has an insertion retainer 27 protruding from the inner surface to retain the battery in a fixed position. The insertion retainer 27 is tubular for the inserted end of the cylindrical battery 1 to be retained in a fixed position; that is to say, the end of the cylindrical battery 1 accommodated in the storage portion 13 of the holder main body 10 is inserted and retained in a fixed position. The cylindrical battery 1 shown in the sectional view in FIG. 8 has at its opposite ends the terminal electrodes 6 which are narrower than the battery main body, and the terminal electrodes 6 are inserted into the insertion retainer 27 to be disposed in a fixed position. In the cylindrical battery 1 inserted in the storage portion 13, the terminal electrodes 6 provided at opposite ends are inserted into the insertion retainer 27 of the end plate 20 and disposed in a fixed position of the storage portion 13. Disposition of the battery in a fixed position in the storage portion 13 is vital to obtain an accurate interval of the cooling gap 7 between the battery and the opposed wall 12. This is because when the position of the battery is offset toward a radial direction, the cooling gap 7 becomes imbalanced, disabling the battery surface to be uniformly cooled. The cylindrical battery 1 with its opposite ends being inserted into the insertion retainer 27 of the end plate 20 and disposed in a fixed position can be cooled in an ideal state when the cooling gap 7 is accurately defined with respect to the battery surface.

Further, the holder main body 10 shown in FIG. 8 has a retention protrusion 29 formed integrally with the inner surface of the storage portion 13 to retain the inserted cylindrical battery 1 in a fixed position. The illustrated holder main body 10 has the retention protrusion 29 projecting toward the center of the storage portion 13 to retain the center portion of the cylindrical battery 1.

Since the above-described battery holder 2 retains the center portion of the cylindrical battery 1 by means of the holder main body 10 and retains the opposite ends of the battery in a fixed position by means of the end plate 20, the respective cylindrical battery 1 can be disposed in an accurate position within the battery holder 2.

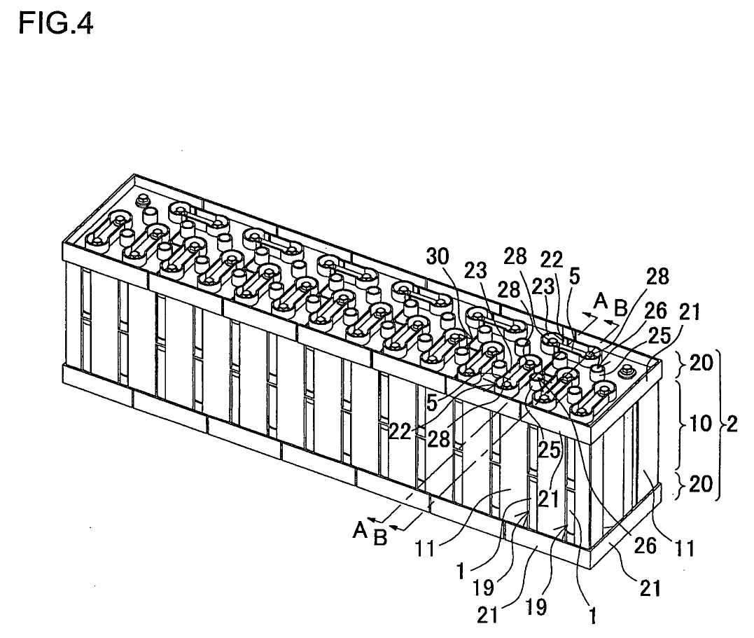

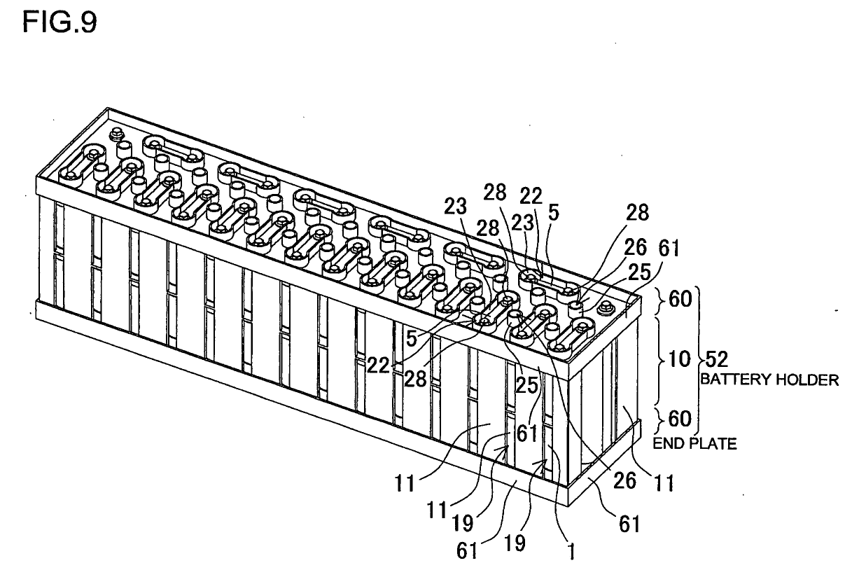

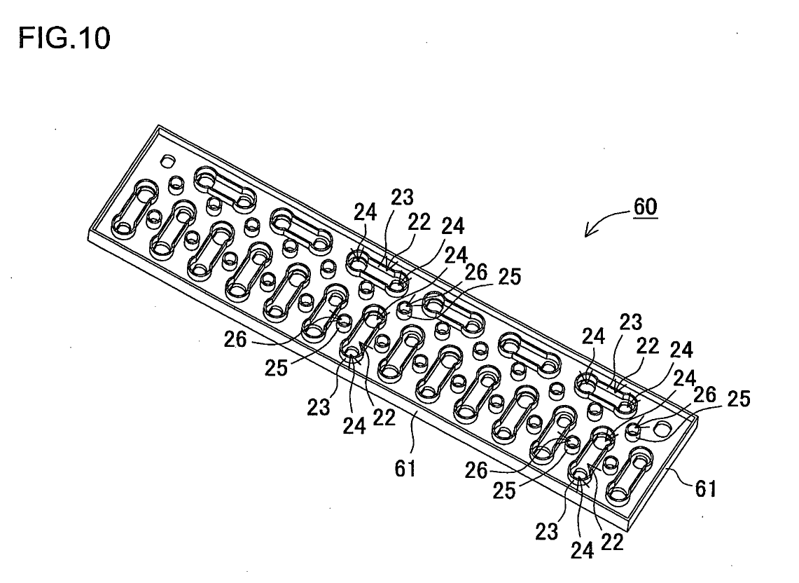

The end plate 20 shown in FIG. 4 and FIG. 6 is divided into a plurality of portions to make each individual length shorter. While the gap 30 produced by such division is adjusted to absorb a dimension error between the end plate 20 and the holder main body 10, the end plate 20 thus divided into the plurality of portions is secured in an accurate position of the holder main body 10. In particular, the end plate 20 is secured in an accurate position of the holder main body 10 when the dimension error in the length-wise direction of the elongate end plate 20 is absorbed by the gap 30 produced by the division. Since the end plate 20 and the holder main body 10 are connected via the connection rod 8, the divided end plate 20 is interconnected in an accurate position via the connection rod 8. The connection rod 8 is inserted into a connection hole 26 of the end plate 20, identifies a position relative to the end plate 20, and is further inserted into the through hole 16 of the holder main body 10 and identifies a position relative to the holder main body 10 to connect the end plate 20 and the holder main body 10 in an accurate position. It should be noted, however, that the battery pack of the present invention may be so structured as not to disassemble the end plate 60 as shown in FIG. 9 and FIG. 10. In these particular drawings, the battery holder is designated by the reference numeral 52, while the fit-on wall is designated by the reference numeral 61.

The pair of end plates 20 are secured to the holder main body 10 via the connection rod 8. In the battery pack shown in FIG. 2 and FIG. 7, the end plate 20 is secured to the holder main body 10 by means of the connection rod 8 securing the outer casing 3. Therefore, the connection rod 8 extends through the outer casing 3, the end plate 20, and the holder main body 10. The illustrated connection rod 8 secures the outer casing 3, the end plate 20, and the holder main body 10 by means of a bolt having at its tip an externally threaded screw 8B, with a nut 9 being screw-threaded on to the externally threaded screw 8B. The outer casing 3 has an insertion hole 36 defined in the position where the connection rod 8 is inserted. The outer casing 3 shown in FIG. 3 has a groove 37 defined which extends in the longitudinal direction, with the groove 37 having the insertion hole 36 opened. The outer casing 3 can be so structured that the bolt head 8A and the nut 9 of the connection rod 8 are guided to the groove 37 in a manner that they do not project from the outer casing 3. Further, the battery pack shown in FIG. 2 and FIG. 3 has a through hole 16 through which a connection rod 8 is not inserted, by disposing in a staggered manner the connection rod 8 which is inserted into the through hole 16, without inserting the connection rod 8 into every through hole 16 of the holder main body 10. In the battery pack, when the through hole 16 into which the connection rod 8 is not inserted is connected water-tightly, the battery can be forcibly cooled by causing the cooling medium to flow for cooling the battery.

In the battery pack shown in FIG. 2, although the end plate 20 is secured to the holder main body 10 by means of the connection rod 8 securing the outer casing 3, the battery pack can also be so structured that the connection rod is extended through the end plate and the holder main body, that the end plate is secured to the holder main body by means of the connection rod, and that the outer casing is secured to the battery holder by means of another set screw.

It should be apparent to those with an ordinary skill in the art that while various preferred embodiments of the invention have been shown and described, it is contemplated that the invention is not limited to the particular embodiments disclosed, which are deemed to be merely illustrative of the inventive concepts and should not be interpreted as limiting the scope of the invention, and which are suitable for all modifications and changes falling within the scope of the invention as defined in the appended claims. The present application is based on Application No. 2008-48,507 filed in Japan on Feb. 28, 2008, the content of which is incorporated herein by reference.

What is claimed is:

1. A battery pack comprising:
a plurality of cylindrical batteries; and
a plastic-made battery holder accommodating the plurality of batteries disposed in a matrix or offset arrangement in a mutually parallel posture, wherein the battery holder comprises:
a holder main body accommodating the cylindrical batteries; and
an end plate respectively connected to opposite ends of the holder main body,
wherein the holder main body has a plurality of opposed walls disposed in a mutually parallel posture inside peripheral walls, and also has a storage portion accommodating the plurality of cylindrical batteries between the opposed walls,
the opposed wall is provided, on its opposite faces, with a protrusion projecting toward the swale between the adjacent cylindrical batteries to constitute a thick portion,
the thick portion defines a through hole extending through in the longitudinal direction of the cylindrical battery, and
a connection rod is inserted in the through hole of the holder main body, and the end plate is secured to the opposite ends of the holder main body by means of the connection rod.

2. The battery pack as recited in claim 1, wherein a cooling gap is defined between the opposed wall and the cylindrical battery to cause a fluid to flow for cooling the battery.

3. The battery pack as recited in claim 1, wherein a cooling medium is forcibly blown through the through hole to cool the cylindrical battery in the storage portion.

4. The battery pack as recited in claim 1, wherein the end plate is so structured as to have a fitting-on portion for disposing a bus bar in a fixed position, the bus bar being connected to a terminal electrode of the cylindrical battery accommodated in the holder main body.

5. The battery pack as recited in claim 1, wherein the end plate is so structured as to have an insertion retainer for inserting and retaining the end of the cylindrical battery in a fixed position, the cylindrical battery being accommodated in the storage portion of the holder main body.

6. The battery pack as recited in claim 1, wherein the holder main body is so structured as to have a retention protrusion for retaining the inserted cylindrical battery in a fixed position, the retention protrusion being on an inner surface of the storage portion.

7. The battery pack as recited in claim 1, wherein the thick portion is cylindrical, has a through hole inside for insertion of the connection rod, and has the protrusion, with its cross section being shaped to be semicircular, at the opposite sides of the opposed wall.

8. The battery pack as recited in claim 1, wherein the thick portion is so structured that a surface of the protrusion is shaped to follow along a surface of the cylindrical battery, and the thick portion has a tube inside for insertion of the connection rod.

9. The battery pack as recited in claim 1, wherein the battery holder accommodates the cylindrical batteries in three rows, the opposed wall has two pieces of protrusions on the opposite sides of the opposed wall, resultantly with the thick portion being formed in two places.

10. The battery pack as recited in claim 1, wherein the opposed wall has the protrusion respectively at the boundary of the cylindrical batteries disposed in the first and second rows and at the boundary of the cylindrical batteries disposed in the second and third rows.

11. The battery pack as recited in claim 10, wherein the thick portion in the windward is cylindrical, has a through hole inside for insertion of the connection rod, and has the protrusion, with a cross section thereof being shaped to be semicircular, at the opposite sides of the opposed wall, while the thick portion in the leeward is larger than the thick portion in the windward, with the surface of the protrusion being shaped to follow along the surface of the cylindrical battery, and has a tube inside for insertion of the connection rod.

12. The battery pack as recited in claim 1, wherein the holder main body has an inlet and outlet to allow the fluid for cooling the battery to flow therethrough.

13. The battery pack as recited in claim 12, wherein the inlet and the outlet are respectively shaped in a slit form extending in the longitudinal direction of the cylindrical battery.

14. The battery pack as recited in claim 13, wherein the inlet is opened on the opposite sides of the respective storage portions, and the outlet is opened in the center portion of the respective storage portions.

15. The battery pack as recited in claim 1, wherein the end plate has a connection hole defined for insertion of the connection rod which is inserted through the through hole of the holder main body.

16. The battery pack as recited in claim 1, wherein the end plate has a support rib integrally formed in the periphery of the connection hole, the support rib projecting from the surface.

17. The battery pack as recited in claim 1 further comprising an outer casing for accommodating the battery holder.

18. The battery pack as recited in claim 10, wherein the end plate has a support rib integrally formed in the periphery of the connection hole, the support rib projecting from the surface, the support rib contacts the inner surface of the outer casing, and thus the outer casing secured to the outside of the end plate is supported from the inner surface.

19. The battery pack as recited in claim 15, wherein the end plate is divided into a plurality of portions and the end plate thus divided into the plurality of portions is connected to the holder main body via the connection rod, while the connection rod is inserted into a connection hole of the end plate and the through hole of the holder main body to interconnect the end plate and the holder main body.

20. The battery pack as recited in claim 10 further comprising a cooling duct between the outer casing and the battery holder.

21. The battery pack as recited in claim 10, wherein the outer casing is a metallic casing.

22. The battery pack as recited in claim 17, wherein the end plate is secured to the holder main body by means of the connection rod securing the outer casing.
